(19) United States
(12) Patent Application Publication
(10) Pub. No.: US 2010/0217945 A1
(43) Pub. Date: Aug. 26, 2010

(54) FAST CONTEXT SAVE IN TRANSACTIONAL MEMORY

(75) Inventors: Yi Ge, Beijing (CN); Rui Hou, Beijing (CN); Huayong Wang, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/708,634

(22) Filed: Feb. 19, 2010

(30) Foreign Application Priority Data
Feb. 26, 2009 (CN) 200910008371.3

(51) Int. Cl. G06F 12/00; G06F 12/06

(52) U.S. Cl. 711/156; 711/202; 711/E12.001; 711/E12.078

(57) ABSTRACT

The present invention provides a method, apparatus and article of manufacture, for fast context saving in transactional memory. The method creates a mapping table that includes entries corresponding to architectural registers. Each entry includes a physical register index and shadow bit of a first physical register mapped to an architectural register. In response to a detection that an update occurs to an architectural register in a transaction and its shadow bit being an invalid value, the method sets the shadow bit to be a valid value and sets a shadow register for the architectural register using the physical register index of the first physical register. The method maps a second physical register to the shadow register in order to save a modified value generated by an update process and saves the original value before the update process by use of the first physical register corresponding to the architecture register.

### CROSS-REFERENCE TO RELATED APPLICATIONS

This application claims priority under 35 U.S.C. §119 from Chinese Patent Application No. 200910008371.3, filed Feb. 26, 2009, the entire contents of which are incorporated herein by reference.

### TECHNICAL FIELD OF THE INVENTION

The present invention relates to a transactional memory of a processor. More specifically the present invention relates to fast context save and restore in the transactional memory of a processor.

### BACKGROUND OF THE INVENTION

Parallel programs are used by more and more applications to get efficient utilization of multi-core resources. However, the complex programming model for the data sharing management makes it difficult to develop the parallel programs. Thus, transactional memory is proposed to provide an easy use mechanism to define and manage the critical section in parallel programs.

In a transactional memory model the program context should be saved at the beginning of a transaction. It will be rollback if a particular event occurs during the transaction that will restore the context saved before the transaction. In the prior art all of the program context will be saved by load and store instructions, which includes architectural registers (ARs), program counters, status registers, stack pointers and so on, that are originally kept in processor's general purpose registers. It takes thousands of cycles to save all of these into main memory in modern micro-architecture. Additionally, the same situation occurs during the rollback stage of the transaction.

A register renaming mechanism that eliminates the WAR (write-after-read) and WAW (write-after-write) dependencies is widely adopted in the pipelines of modern processors. A register renaming mechanism dynamically allocates the physical registers (PRs) to the ARs with some sort of mapping scheme.

FIG. 1 shows a basic relation of the mapping between ARs and PRs.

When an instruction tries to modify an AR (e.g. a1), the renaming mechanism automatically allocates a new PR (r72) to a new instruction and stores the modified value for the instruction into the new PR r72, so as to avoid the confliction with previous issued instructions that accessed the AR a1. If a plurality of instructions access the same AR, then a plurality of corresponding PRs exists for the AR. Thus, the number of PRs is required to be larger than the number of ARs.

In the prior art, all the registers, including modified and unmodified ones, have to be written to and read from memory during the context save and restore procedure, which might take thousands of time cycles. However, in most of the transactions, only several ARs are modified during the whole procedure, while most of the ARs are saved and restored without the modification. This manner results in waste of a great deal of memory resources.

### SUMMARY OF THE INVENTION

Accordingly, an aspect of the invention provides a method for fast context saving in transactional memory. The transactional memory includes a plurality of architectural registers and physical registers. The number of physical registers is larger than the number of the architectural registers. The method creates a mapping table in memory using a processing device. The mapping table includes a plurality of entries corresponding, by a one to one mapping, to a plurality of architectural registers. Each entry in the plurality of entries includes a physical register index and shadow bit of a first physical register mapped to an architectural register. In response to a detection that an update occurs to an architectural register in a transaction and its shadow bit being an invalid value, the method sets the shadow bit to be a valid value and sets a shadow register for the architectural register using the physical register index of the first physical register. The method maps a second physical register to the shadow register in order to save a modified value generated by an update process and saves the original value before the update process by use of the first physical register corresponding to the architecture register.

According to another aspect of the invention, a transactional memory apparatus for fast context saving is provided. The apparatus includes a plurality of architectural registers, a plurality of physical registers, a mapping table, a first module and a second module. The number of physical registers is larger than the number of the architectural registers. The mapping table includes a plurality of entries corresponding, by a one to one mapping, to the plurality of architectural registers, wherein each entry in the plurality of entries includes a physical register index and shadow bit of a first physical register mapped to an architectural register. The first module, in response to a detection that an update occurs to an architectural register in a transaction and its shadow bit being an invalid value, sets the shadow bit to be a valid value and creates a shadow register for the architectural register using the physical register index of the first physical register. The second module maps a second physical register to the shadow register in order to save a modified value generated by an update process and saves the original value before the update process by use of the first physical register corresponding to the architecture register.

The advantage of the present invention is that only the modified context is saved to a renaming register when register renaming occurs so as to reduce the buffer requirements and overhead for a context save and restore.

### BRIEF DESCRIPTION OF THE DRAWINGS

FIG. 1 shows a basic relation of the mapping between ARs and PRs;

FIG. 2 shows a diagram for the operation principle of a method according to an embodiment of the invention;

FIG. 3(a) is a flow chart of a method for fast context saving in transactional memory according to an embodiment of the invention; and

FIG. 3(b) shows a flow chart of a method for restoring or setting after fast context save in transactional memory according to an embodiment of the invention.

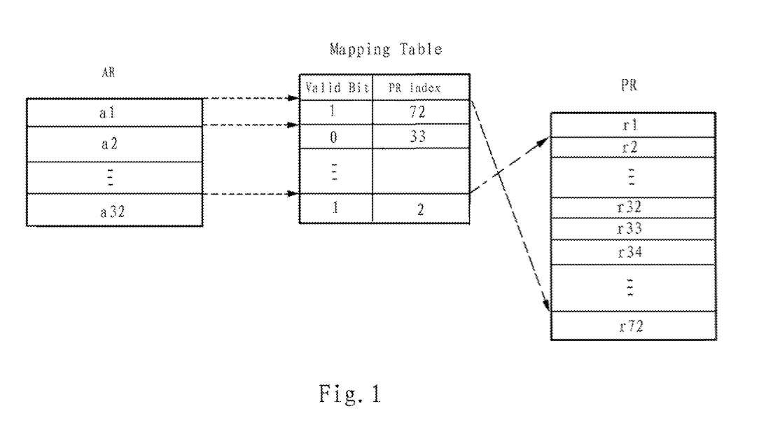

### DESCRIPTION OF THE PREFERRED EMBODIMENTS

The present invention proposes a new method that only saves and restores the modified ARs rather than the unmodified ARs during the transaction with the extension of the renaming register mechanism. The original values of ARs will be kept in the renaming registers instead of memory so that the overhead of the context restoration is reduced to tens of cycles. No explicit context save operation is required at the beginning of the transaction.

Those skilled in the art will better understand the aspects, features and advantages of the invention by detailed description of respective embodiments of the invention in combination with the attached drawings.

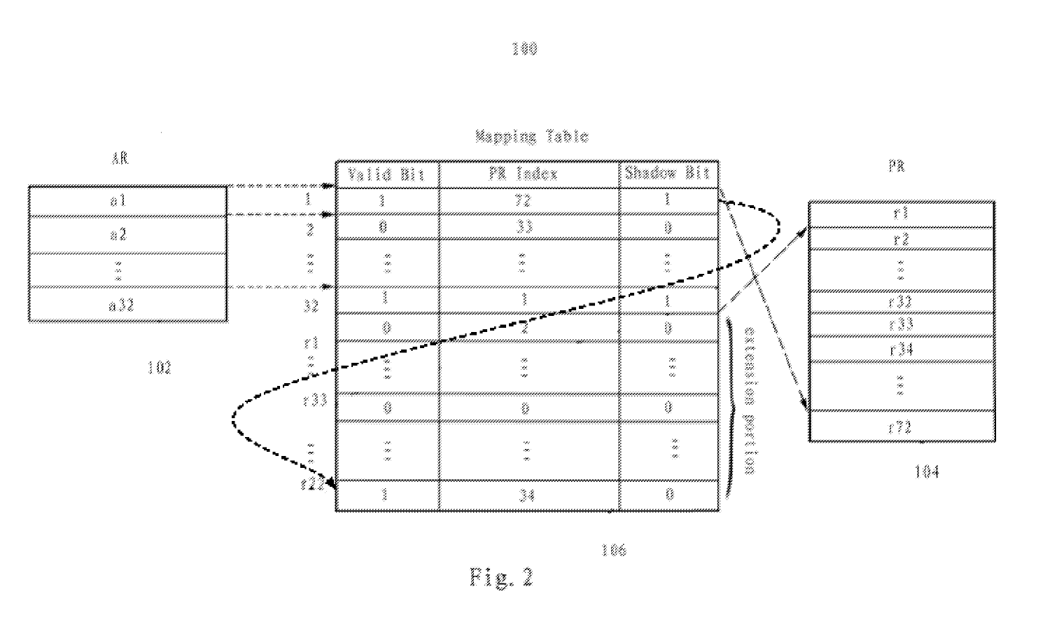

As shown in FIG. 2, the transactional memory 100 according to an embodiment of the present invention includes a plurality of ARs 102 and a plurality of PRs 104. The number of the PRs 104 is larger than the number of the ARs 102. For example, the ARs 102 includes a1, a2, . . . , a32 while the PRs 104 contains r1, r2, r3, . . . , r72.

The transactional memory 100 further includes a mapping table 106. The mapping table is composed of a plurality of entries in the up-to-down direction with each entry representing one of ARs 102. For example, the entry 1 represents AR a1, the entry 2 represents AR a2, . . . , and the entry 32 represents AR a32.

The mapping table consists of three columns in the left-to-right direction. The first column is a valid bit, the second column is a PR Index, and the third column is a shadow bit. In other words, each entry contains three portions, a valid bit, a PR Index, and a shadow bit. A valid bit in an entry corresponding to an AR 102 that has already been used before a transaction may be set as a valid value such as 1 to indicate that it has been used before the transaction. If the valid bit is an invalid value such as 0, then it indicates that it has not been used in the transaction. The PR Index is used to represent the PR (a first PR) 104 being mapped to AR 102 in the transaction. The shadow bit indicates that a value of an AR 102 is changed in the transaction and that a renaming register (a shadow register) is created for AR 102 and a new PR (a second PR) is mapped for the newly created shadow register such as r72, for example represented by PR Index (reference numeral) 34, to store the modified value in replace of the original AR.

The bottom portion of the mapping table 106 includes a plurality of added entries that are composed of the shadow registers created for ARs 102 to be used as renaming registers of the ARs 102. For example, the shadow registers r1, r2, . . . , r33, . . . , r72. The entries representing the shadow registers are composed the same as the entries representing the ARs 102.

According to an embodiment of the invention, the entry 1 represents AR a1. The valid bit is 1 to indicate that the AR a1 has been used before a transaction. The PR Index is 72 to indicate that the PR (the first PR) mapped to the AR a1 before the transaction is r72. If the shadow bit is 1, it indicates that the value of the AR a1 has been changed in the transaction, that is, at least one instruction accessing the same AR a1 exists in the transaction, resulting in register update operation. At this time, a new entry r72 is created for the AR a1 to represent the renaming register of the AR a1, i.e. the shadow register, and a new PR (the second PR) is mapped for the shadow register r72, for example the index of the new PR being 34, to store the modified value in the transaction on behalf of the original AR.

Because the shadow bit in the entry 1 representing the AR a1 is 1 and the PR Index in this entry is 72, the shadow register r72 is utilized to record the renaming status of the AR a1 on behalf of the AR a1 until a rollback occurs during the transaction or the shadow bit is reset due to the completion of the transaction. The content in the entry of the AR a1 keeps unchanged during the transaction. Viewed from register aspect, the entry of the shadow register r72 not only keeps the original value of the AR a1 in the register (a first PR r72), but also records the modified value of the register in the transaction (using a second PR such as r34).

When a rollback occurs due to appearance of a particular event during the transaction, the values of shadow bits are reset, in other words their values are reset to 0, and the shadow register and its corresponding second PR is cleared so as to restore the ARs 102 to the original value before the transaction.

Alternatively, when the transaction is completed, the modified values saved in the second PRs corresponding to the respective shadow registers are copied into corresponding ARs 102 to replace the original values therein, and the shadow registers and their corresponding second PRs are released to AVAILABLE state.

It should be noted that the valid bits of ARs 102 do not constitute any limitation of the technical scope of the present invention and embodiments of the invention may not include any valid bit.

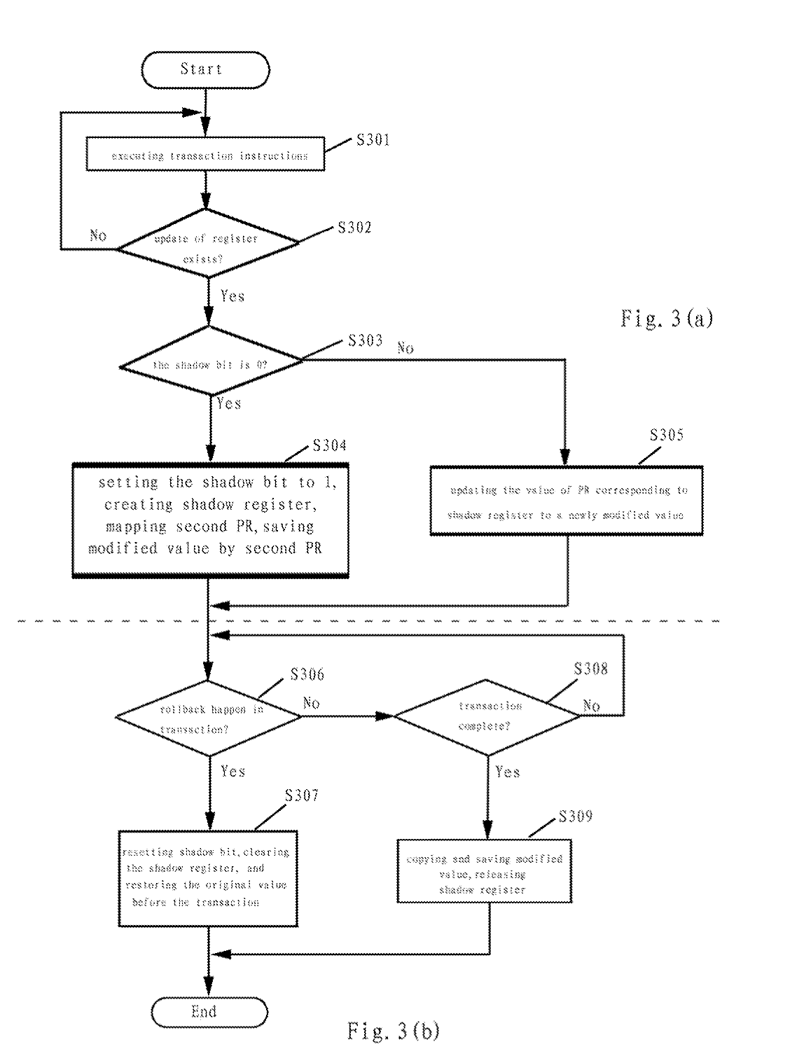

FIG. 3(a) is a flow chart showing a method for fast context saving in transactional memory according to an embodiment of the invention. FIG. 3(b) shows a flow chart of a method for restoring or setting after context save in transactional memory according to an embodiment of the invention.

In a normal state, only the ARs 102 are utilized in the transaction and the entries of the PRs and the shadow bits are kept in unused state.

By reference to FIG. 3(a), after the procedure starts for a transaction, it goes to step S301. In step S301 the transaction instruction is executed and whether the update occurs to ARs 102 in the transaction is decided at step S302. If no update occurs to the ARs 102 in the transaction at step S302, the procedure returns to step S301 and the normally used register state it kept and no context saving operation occurs. In step S301, it is option to set a transactional memory flag to indicate the state of the transaction. An update occurring to the ARs 102 in the transaction means that at least one instruction accessing the same AR 102 exists, thus resulting in an access update.

If an update occurs to the ARs 102, such as a1, in the transaction in step S302, it proceeds to step S303. At step S303 it is determined whether the shadow bit in the entry representing the ARs 102 in the mapping table 106 is 0. If it is determined that the shadow bit in the entry representing the AR 102 in the mapping table 106 is 0 in step S303, that means this is the first change for the value of the AR 102 in the transaction, then the process proceeds to the S304, otherwise the process proceeds to step S305.

In step S304, the shadow bit is set as a valid value, such as 1, and the shadow register is created of the AR 102 using the PR Index, which represents a first PR corresponding to the AR a1, in the entry representing the AR 102, such as a1, and map a new PR (a second PR, such as r34, represented by its index 34) to the shadow register, such as r72. The modified value under the update process is saved in the new PR (r34), and the original value before the update process is saved in the original PR (the first PR) corresponding to the AR 102, such as a1.

If it is determined that the shadow bit in the entry representing the AR 102 (a1) is not 0 in step S303 that means it is not the first time that the value of the AR 102 (a1) has been changed in the transaction and that the shadow register corresponding to the AR 102 (a1) already existed. At this time, in step S305, it is only needed to update the value in the (second) PR mapped by the shadow register to be a newly modified value.

By reference to FIG. 3(b), a method for restoring or setting after context save in transactional memory is described.

The process proceeds to step S306 from step S304 or S305. In step S306, it is determined whether a rollback occurs due to a particular event in the transaction. If it is determined that a rollback occurs in the transaction in step S306, then the process proceeds to step S307, otherwise the process goes to step S308.

In step S307, in response to the rollback occurring in the transaction, the values of the shadow bits are reset, in other words their values are reset to 0, and the shadow register and its corresponding second PR are cleared, so as to restore the AR 102 to the original value before the transaction. Then the transaction terminates.

In step S308, it is determined whether the transaction has been completed. If it is determined that the transaction has been completed in step S308, then the process proceeds to the step S309, otherwise the process returns to the step S306.

In step S309, in response to the completion of the transaction, the modified values saved in the second PRs corresponding to the respective shadow registers are copied into the corresponding ARs 102 to replace the original values saved therein. The shadow registers and the corresponding second PRs are released to AVAILABLE state. Then, the transaction terminates.

The order for performing the respective steps as above according to embodiments of the present invention does not constitute a limitation of the technical scope of the invention. For example, the orders for performing the above steps S306 and S308 can be exchanged, and all the steps can be performed in a parallel order.

Although some embodiments of the present invention have been shown and described in combination with the attached drawings, those skilled in the art should understand that a variation and modification can be made to those embodiments without departing from the principle and spirit of the invention.

What is claimed is:

1. A method of fast context saving in transactional memory, the method comprising the steps of:
creating a mapping table in memory using a processing device, wherein the mapping table includes a plurality of entries corresponding, by a one to one mapping, to a plurality of architectural registers and wherein each entry includes a physical register index and shadow bit of a first physical register mapped to an architectural register;
in response to a detection that an update occurs to an architectural register in a transaction and its shadow bit being an invalid value, setting the shadow bit to be a valid value and creating a shadow register for the architectural register using the physical register index of the first physical register; and
mapping a second physical register to the shadow register in order to save a modified value generated by an update process and saving the original value before the update process by use of the first physical register corresponding to the architecture register.

2. The method of claim 1, further comprising the steps of, in response to a rollback occurring during the transaction, resetting the shadow bits and clearing the shadow register and the second physical register, so as to restore the architectural register to an original value.

3. The method of claim 1, further comprising the steps of, in response to completion of the transaction, replacing the original value of the corresponding architectural register with the modified value of the shadow register and releasing the shadow register and the second physical register to an available state.

4. The method of claim 1, further comprising the step of directly updating the modified value in the second physical register with a newly modified value in response to a detection that an update in the transaction occurred to the architectural register and its shadow bit being a valid value.

5. The method of claim 1, wherein each entry in the plurality of entries of the mapping table further includes a valid bit that is used to mark the architectural register utilized in the transaction to be valid.

6. A transactional memory apparatus for fast context saving, the apparatus comprising:
a plurality of architectural registers;
a plurality of physical registers, wherein the number of physical registers is larger than the number of the architectural registers;
a mapping table that includes a plurality of entries corresponding, by a one to one mapping, to the plurality of architectural registers, wherein each entry in the plurality of entries includes a physical register index and shadow bit of a first physical register mapped to an architectural register;
a module for, in response to a detection that an update occurs to an architectural register in a transaction and its shadow bit being an invalid value, setting the shadow bit to be a valid value and creating a shadow register for the architectural register using the physical register index of the first physical register;
a module for mapping a second physical register to the shadow register in order to save a modified value generated by an update process and saving the original value before the update process by use of the first physical register corresponding to the architecture register.

7. The transactional memory apparatus of claim 6, further comprising a module for, in response to a rollback occurring during the transaction, resetting the shadow bits and clearing the shadow register and the second physical register, so as to restore the architectural register to an original value.

8. The transactional memory apparatus of claim 6, further comprising a module for, in response to completion of the transaction, replacing the original value of the corresponding architectural register with the modified value of the shadow register and releasing the shadow register and the second physical register to an available state.

9. The transactional memory apparatus of claim 6, further comprising a module for directly updating the modified value in the second physical register with a newly modified value in response to a detection that an update in the transaction occurred to the architectural register and its shadow bit being a valid value.

10. The transactional memory apparatus of claim 6, wherein each entry in the plurality of entries of the mapping table further includes a valid bit that is used to mark the architectural register utilized in the transaction to be valid.

11. A computer readable article of manufacture tangibly embodying computer readable instructions for executing the steps of:
creating a mapping table that includes a plurality of entries corresponding, by a one to one mapping, to a plurality of architectural registers, wherein each entry in the plurality of entries includes a physical register index and shadow bit of a first physical register mapped to an architectural register;
in response to a detection that an update occurs to an architectural register in a transaction and its shadow bit being an invalid value, setting the shadow bit to be a valid value and setting a shadow register for the architectural register using the physical register index of the first physical register;
mapping a second physical register to the shadow register in order to save a modified value generated by an update process and saving the original value before the update process by use of the first physical register corresponding to the architecture register.
